(19) United States
(12) Patent Application Publication
(10) Pub. No.: US 2015/0248144 A1
(43) Pub. Date: Sep. 3, 2015

(54) DISPLAY SYSTEM AND OPERATING METHOD THEREOF

(71) Applicant: Samsung Display Co., Ltd., Yongin-city (KR)

(72) Inventors: Jeongjin HONG, Yongin-si (KR); Chan Young PARK, Yongin-si (KR); Jongsung BAE, Hwaseong-si (KR); Donghyeon LEE, Seoul (KR); Jusuck LEE, Seoul (KR); Heesoon JEONG, Hwaseong-si (KR); Seongmin CHO, Seoul (KR); Eunsil HAN, Hwaseong-si (KR)

(21) Appl. No.: 14/560,470

(22) Filed: Dec. 4, 2014

(30) Foreign Application Priority Data
Mar. 3, 2014 (KR) 10-2014-0025112

(51) Int. Cl. G06F 1/16

(52) U.S. Cl. CPC G06F 1/1675; G06F 1/1652; G06F 1/1626

(57) ABSTRACT

A display system includes a display unit including a flexible display panel for displaying images; movement units disposed at first and second ends of the flexible display panel and configured to move while rotating the flexible display panel in a predetermined direction; a transceiver unit configured to transmit and receive a wireless signal; a laser sensor configured to output a laser and to receive a reflected laser; a movement route processor configured to calculate a movement route to a target position based on data associated with a sensitivity of a laser sensed by the laser sensor; and a control unit configured to control the movement units so as to move into the target position along the movement route, calculated by the movement route processor, when a movement command is received from an external device through the transceiver unit.

### CROSS-REFERENCE TO RELATED APPLICATIONS

This application claims priority from and the benefit of Korean Patent Application No. 10-2014-0025112, filed on Mar. 3, 2014, which is hereby incorporated by reference for all purposes as if fully set forth herein.

### BACKGROUND

1. Field

Exemplary embodiments of the inventive concepts described herein relate to a display system with a flexible display panel and an operating method thereof.

2. Discussion of the Background

Small-sized electronic devices, such as portable telephones, portable game machines, remote controllers, point of sale (POS) terminals, navigation systems, etc., have a display panel for displaying images. In recent years, development of display panel technology has included research of a flexible display panel. As a display system with a flexible display panel may be folded or rolled, its size is reduced. Thus, it is easy to carry the display system.

Since a display system is used in a variety of applications, there is an increasing need for a display system with a variety of functions and portability options for user convenience.

### SUMMARY

Exemplary embodiments of the present invention provide a portable display system capable of moving to a location.

Additional features of the invention will be set forth in the description which follows, and in part will be apparent from the description, or may be learned by practice of the invention.

An exemplary embodiment of the present invention discloses a display system including a display unit including a flexible display panel for displaying images; movement units disposed at first and second ends of the flexible display panel and configured to move while rotating the flexible display panel in a predetermined direction; a transceiver unit configured to transmit and receive a wireless signal; a laser sensor configured to output a laser and to receive a reflected laser; a movement route processor configured to calculate a movement route to a target position based on data associated with a sensitivity of a laser sensed by the laser sensor; and a control unit configured to control the movement units so as to move into the target position along the movement route, calculated by the movement route processor, when a movement command is received from an external device through the transceiver unit.

An exemplary embodiment of the present invention also discloses an operating method of a display system including receiving a movement command; outputting a laser to sense a reflected laser; calculating a movement route to a target position based on a sensitivity of the sensed laser; and controlling a motor such that the display system moves along the motor. The motor rotates movement units disposed at first and second ends of a flexible display panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram schematically illustrating a display system according to an exemplary embodiment of the inventive concept.

FIG. 2 is a cross-sectional view of a first movement unit of the display system shown in FIG. 1.

FIG. 3 is a block diagram schematically illustrating the display system shown in FIG. 1, according to an exemplary embodiment of the inventive concept.

FIG. 4 is a block diagram schematically illustrating the display unit shown in FIG. 3, according to an exemplary embodiment of the inventive concept.

FIG. 5 is a diagram schematically illustrating a route through which the display system shown in FIG. 1 moves into a target position at which a portable terminal is placed.

FIG. 6 is a flowchart schematically illustrating operation of a control unit of display system shown in FIG. 3.

FIG. 7 is a diagram schematically illustrating a display system according to an exemplary embodiment of the inventive concept.

FIG. 8 is a cross-sectional view of a first movement unit of the display system shown in FIG. 7.

FIG. 9 is a diagram schematically illustrating a display system according to an exemplary embodiment of the inventive concept.

FIG. 10 is a diagram schematically illustrating an exemplary embodiment where a display panel of a display system shown in FIG. 9 is rolled in first and second rollers.

### DETAILED DESCRIPTION OF THE ILLUSTRATED EMBODIMENTS

Exemplary embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, operations, operations, elements, and/or components, but do not preclude the presence or addition of one or more other features, integers, operations, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

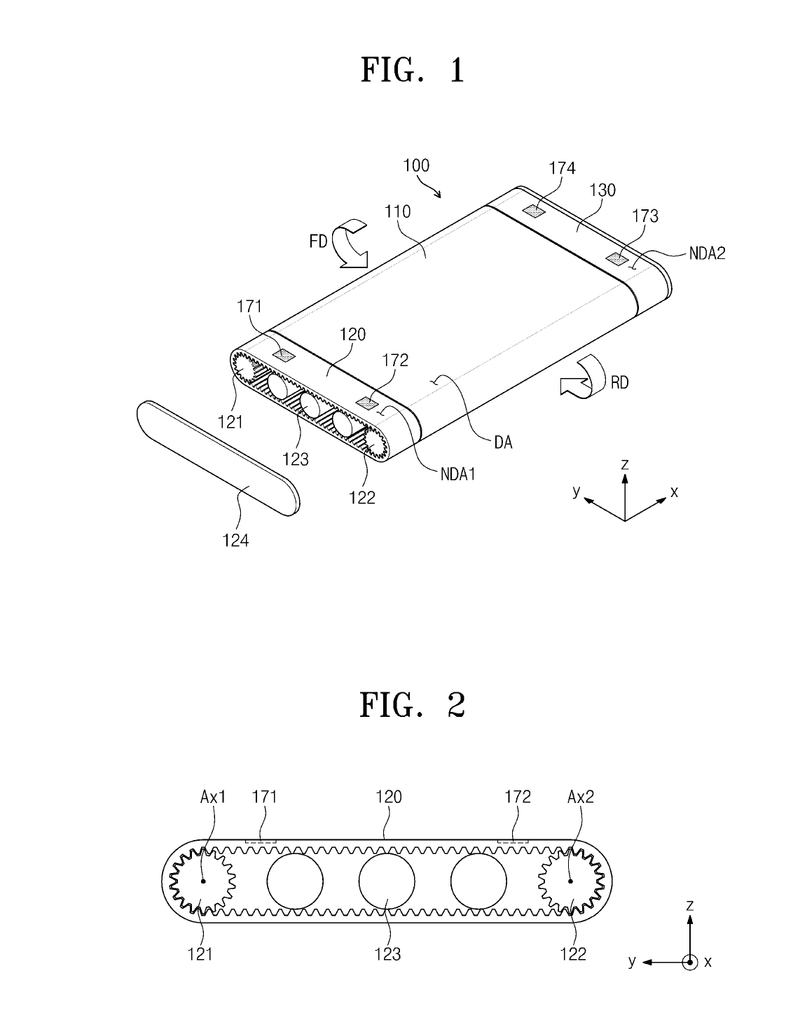

FIG. 1 is a diagram schematically illustrating a display system according to an exemplary embodiment of the inventive concept. FIG. 2 is a cross-section view of a first movement unit of a display system shown in FIG. 1.

Referring to FIGS. 1 and 2, a display system 100 has a long edge in a first direction x, a short edge in a second direction y, and a height in a third direction z. The display system 100 may be one of portable electronic systems, such as a portable telephone, a remote controller, a game console, a point of sale (POS) terminal, a navigation system, a medical terminal, etc.

The display system 100 includes a display panel 110, a first movement unit 120, and a second movement unit 130. The display panel 110 is configured to cover an entire surface of or a substantial portion of the surface of the display system 100. The display panel 110 includes a display area DA, a first non-display area NDA1, and a second non-display area NDA2. The display panel 110 may be a flexible display panel.

The first movement unit 120 and the second movement unit 130 may be used to move the display system 100. The first movement unit 120 and the second movement unit 130 are disposed at a first end and a second end of the display panel 110, respectively. That is, the first movement unit 120 is disposed in the first non-display area NDA1 of the display panel 110, and the second movement unit 130 is disposed in the second non-display area NDA2 thereof.

The first movement unit 120 and the second movement unit 130 may have the same structure. The first movement unit 120 includes a first pulley 121, a second pulley 122, wheels 123, and a cover unit 124. The first pulley 121 rotates on the first axis Ax1 according to rotation of a motor (not shown), and the second pulley 122 rotates on the second axis Ax2 according to rotation of a motor (not shown). The first pulley 121, which rotates on the first axis Ax1, has external saw teeth with a set pitch. The second pulley 122, which rotates on the second axis Ax2, has external saw teeth with a set pitch. The pitch of the external saw teeth of the second pulley 122 is equal to that of the first pulley 121.

The display panel 110 covers outer surfaces of the first and second pulleys 121 and 122. Internal teeth, having the same pitch as the external saw teeth of each of the first and second pulleys 121 and 122, are provided on the inside of the first non-display area NDA1 of the display panel 110. That is, the external saw teeth on the inside of the first non-display area NDA1 are on a surface being in contact with the first pulley 121. Thus, the external saw teeth of the first and second pulleys 121 and 122 engage with internal saw teeth of the first non-display area NDA1 of the display panel 110. The first non-display area NDA1 and the second non-display area NDA2 of the display panel 110 may be formed of an elastic material, such as rubber.

The first movement unit 120 has one or more wheels 123, which are disposed between the first pulley 121 and the second pulley 122. The wheels 123 support the first non-display area NDA1 of the display panel 110.

As the first movement unit 120 and the second movement unit 130 rotate, the display panel 110 rotates in a forward direction FD or in a backward direction RD. The display system 100 moves in a second direction y or in a direction opposite to the second direction y according to rotation of the display panel 110. Since the display panel 110 is a flexible display panel, upon rotation and movement, a shape of the display panel 110 may vary according to a shape of a surface being in contact with a bottom surface of the display panel 110.

A first laser sensor 171 and a second laser sensor 172 are provided in the first non-display area NDA1 of the display panel 110. A third laser sensor 173 and a fourth laser sensor 174 are provided in the second non-display area NDA2 of the display panel 110. Although four laser sensors are shown, the invention is not limited thereto. For example, laser sensors may be provided on the movement units 120 and 130, opposite laser sensors 171, 172, 173, and 174, i.e., on a bottom or other side of the display system 100.

The first to fourth laser sensors 171 to 174 output lasers, and receive reflected lasers to calculate a distance between the display system 100 and an obstacle (e.g., walls, home appliances, etc.)

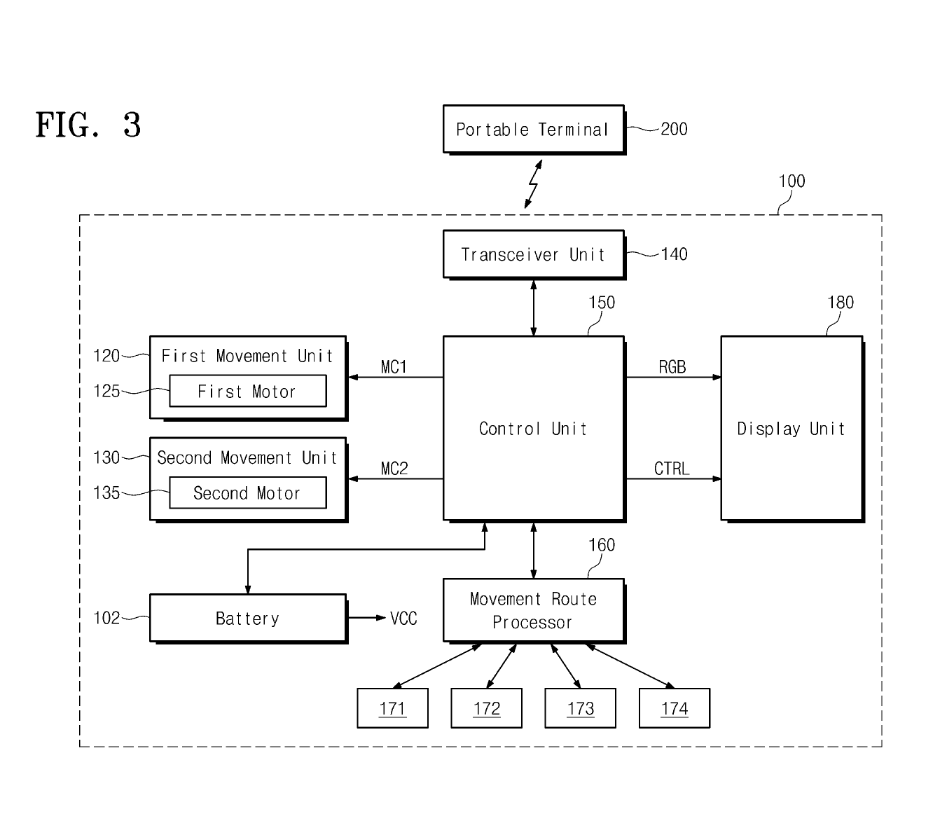

FIG. 3 is a block diagram schematically illustrating a display system shown in FIG. 1, according to an exemplary embodiment of the inventive concept.

Referring to FIG. 3, a display system 100 performs wireless communications with an external device (e.g., a portable terminal) 200. The portable terminal 200 may be one of, but not limited to, a smart watch, a remote controller, a game system, a television, a computer, an ear set, a wearable electronic device, a home appliance, a battery charger, etc. Communications between the display system 100 and the portable terminal 200 may be made using a variety of wireless communication manners, for example, WiFi, WiGig, Bluetooth, wireless LAN, etc.

The display system 100 includes a battery 102, a first movement unit 120, a second movement unit 130, a transceiver unit 140, a control unit 150, a movement route processor 160, laser sensors 171 to 174, and a display unit 180. The battery 102 provides a power supply voltage VCC for powering the display system 100. The battery 102 may be a rechargeable battery. The control unit 150 measures remaining power of the battery 120 to display the remaining power on the display unit 180. The control unit 150 operates in a power saving mode when the remains of the battery 102 is less than a set level (e.g., 10%). During the power saving mode, for example, the control unit 150 blocks power to the display unit 180 in order for the display system 100 to move minimally.

The transceiver unit 140 wirelessly communicates with the portable terminal 200. The transceiver unit 140 may be disposed at a first end of a display panel 110 and includes a first motor 125. To rotate a first pulley 121 and a second pulley 122, the first motor 125 rotates a first driving axis Ax1 and a second driving axis Ax2 in response to a first motor control signal MC1 from the control unit 150. As illustrated in FIG. 1, a second movement unit 130 is disposed at a second end of the display panel 110, and includes a second motor 135. The second motor 135 operates in response to a second motor control signal MC2 from the control unit 150. The display panel 110 shown in FIG. 1 rotates in a forward direction FD or in a backward direction RD, based on operations of the first and second movement units 120 and 130.

If a movement command is received from the portable terminal 200, the control unit 150 provides the first motor control signal MC1 and the second motor control signal MC2 to the first movement unit 120 and the second movement unit 130, such that the display panel 110 moves in the forward direction FD or in the backward direction RD with at least one of the first movement unit 120 and the second movement unit 130. The first movement unit 120 and the second movement unit 130 may move and be controlled independently from each other, and the display panel 110 may rotate with one, both, or neither of the first movement unit 120 and the second movement unit 130. The control unit 150 provides the movement route processor 160 with target position information and a movement route calculation command. The target position information may be position information provided from the portable terminal 200. The portable terminal 200 provides the display system 100 with position information. For example, the position information may include position information of a position at which the display system 100 will arrive.

If the movement route calculation command is received from the control unit 150, the movement route processor 160 operates the first to fourth laser sensors 171 to 174. The first to fourth laser sensors 171 to 174, as illustrated in FIG. 1, are disposed in a first non-display area NDA1 and a second non-display area NDA2 of the display panel 110. When the display panel 110 rotates in the forward direction FD or in the backward direction RD, the first to fourth laser sensors 171 to 174 output lasers. Further, the first to fourth laser sensors 171 to 174 may output and receive lasers independent of the rotation or movement of the display panel 110. The first to fourth laser sensors 171 to 174 receive lasers reflected by obstacles to provide the movement route processor 160 with data about distances between the sensors and obstacles.

The movement route processor 160 calculates a distance between the display system 100 and the obstacles based on sensitivity and reception time information about lasers received from the first to fourth laser sensors 171 to 174. The movement route processor 160 calculates an optimal movement route through which the display system 100 will arrive at the target position, which is provided from the control unit 150, based on the calculated distance data. The movement route processor 160 provides the calculated movement route to the control unit 150. The movement route processor 160 iterates an operation of calculating the movement route until the display system 100 reaches the target point. The movement route processor 160 tracks the movement route to the target position using a position tracking algorithm. For example, the movement route processor 160 may track the movement route to the target position using a particle filter.

The display unit 180 displays images in response to an image signal RGB and a control signal CTRL from the control unit 150.

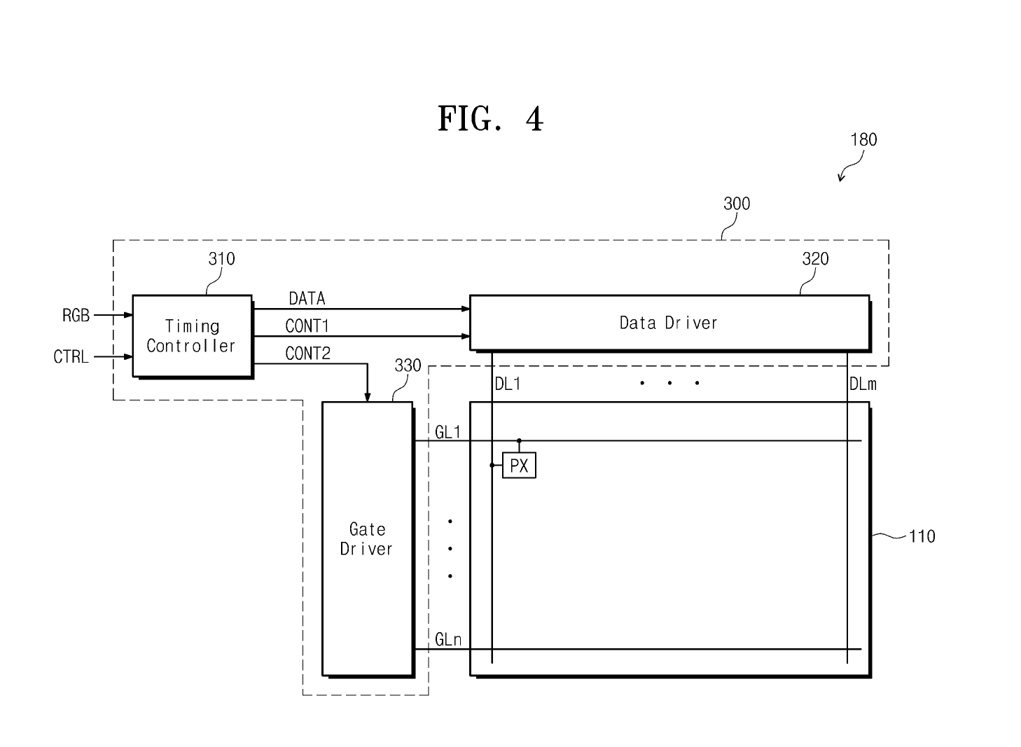

FIG. 4 is a block diagram schematically illustrating a display unit shown in FIG. 3, according to an exemplary embodiment of the inventive concept.

Referring to FIG. 4, a display unit 180 includes a display panel 110 and a driving unit 300 controlling the display panel 110 such that an image may be displayed thereon. The driving unit 300 includes a timing controller 310, a data driver 320, and a gate driver 330.

The display panel 110 includes a plurality of gate lines GL1 to GLn, a plurality of data lines DL1 to DLm, and a plurality of pixels PX connected to the plurality of gate lines GL1 to GLn and the plurality of data lines DL1 to DLm. The plurality of gate lines GL1 to GLn and the plurality of data lines DL1 to DLm may be disposed to be isolated from one another.

The timing controller 310 receives an image signal RGB and a control signal CTRL from a control unit 150 shown in FIG. 3. The control signal CTRL is used to control expression of the image signal RGB. For example, the control signal CTRL may include a vertical synchronization signal, a horizontal synchronization signal, a main clock signal, a data enable signal, etc. The timing controller 310 processes the image signal RGB to be suitable for the display panel 110 to output a data signal DATA. The timing controller 310 generates a first control signal CONT1 based on the control signal CTRL. The timing controller 310 provides the data driver 320 with the data signal DATA and the first control signal CONT1 and the gate driver 330 with a second control signal CONT2. The first control signal CONT1 may include a horizontal synchronization start signal, a clock signal, and a lane latch signal, and the second control signal CONT2 may include a vertical synchronization start signal and an output enable signal.

The gate driver 330 drives the plurality of gate lines GL1 to GLn in response to the second control signal CONT2 from the timing controller 310. The gate driver 330 may be implemented with a circuit using an ASG (Amorphous silicon gate), an oxide semiconductor, a crystalline semiconductor, a polycrystalline semiconductor, etc., and may be formed on the same substrate as the display panel 110.

The data driver 320 outputs gray scale voltages for driving the data lines DL1 to DLm in response to the data signal DATA and the first control signal CONT1 from the timing controller 310.

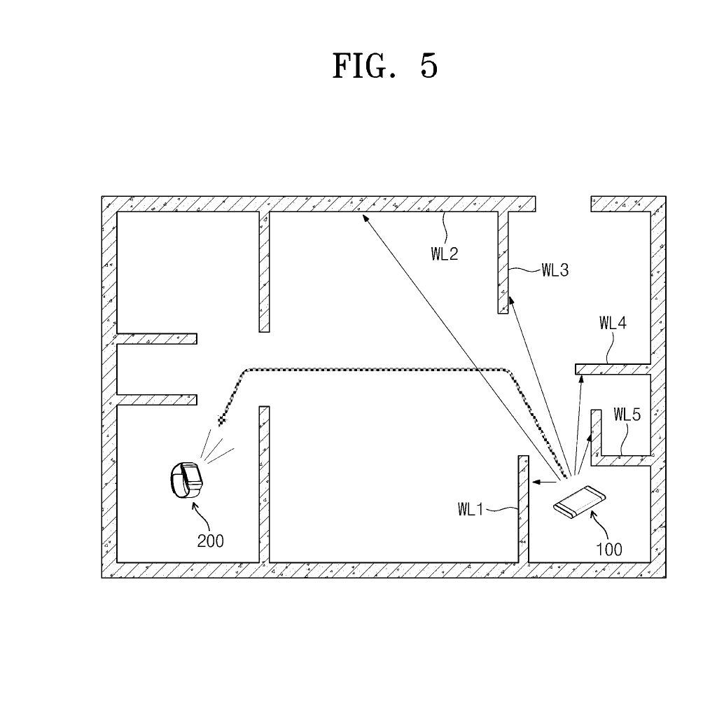

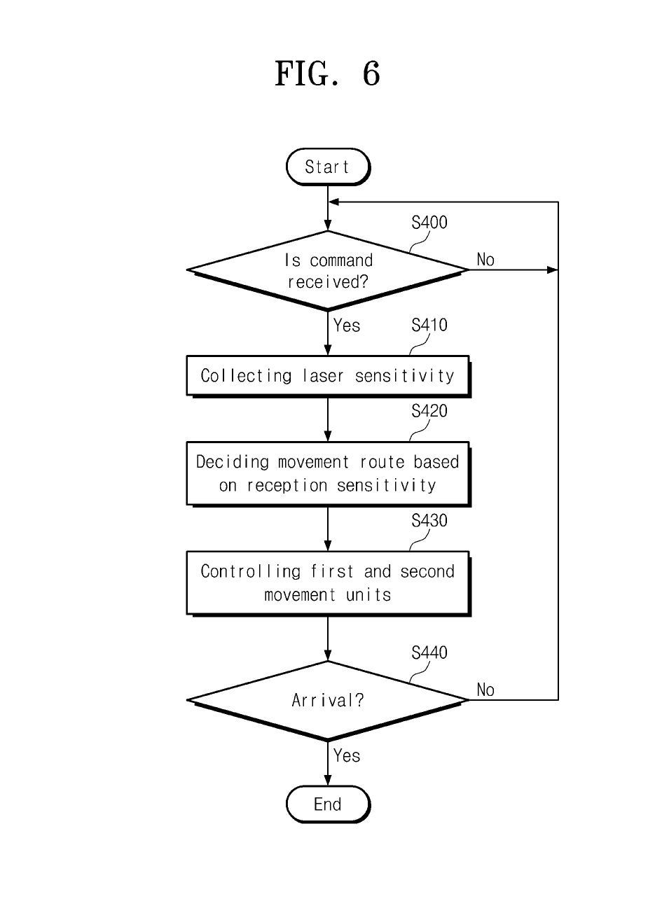

FIG. 5 is a diagram schematically illustrating a route through which a display system shown in FIG. 1 moves into a target position where a portable terminal is placed. FIG. 6 is a flow chart schematically illustrating an operation of a control unit of a display system shown in FIG. 3.

Referring to FIGS. 3 and 5, a portable terminal 200 transfers a movement command and target position information to a display system 100. When the movement command is received, in operation 5400, the control unit 150 provides a movement route processor 160 with the target position information. The control unit 150 issues a first motor control signal MC1 and a second motor control signal MC2 such that a first movement unit 120 and a second movement unit 130 operate. As the first movement unit 120 and the second movement unit 130 operate, a display system 100 rotates in a forward direction FD or in a backward direction RD.

The movement route processor 160 controls laser sensors 171 to 174 to operate. As the display system 100 rotates in a forward direction FD or in a backward direction RD, the laser sensors 171 to 174 output lasers and receive reflected lasers. The laser sensors 171 to 174 provide the movement route processor 160 with sensitivity and reception time information associated with the received lasers.

In operation S410, the movement route processor 160 collects the sensitivity and reception time information from the laser sensors 171 to 174 during a set time. The movement route processor 160 calculates a distance between the display system 100 and the obstacles WL1 to WL5 based on the sensitivity and reception time information thus collected. In operation S420, the movement route processor 160 decides an optimal movement route by which the display system 100 will move to a target position provided from the control unit 150, based on the calculated distance data. The movement route processor 160 provides the decided movement route to the control unit 150.

In operation S430, the control unit 150 provides the first and second motor control signals MC1 to MC2 to the first and second movement units 120 and 130 such that the display system 100 moves along the decided movement route.

When the display system 100 arrives at a target position, for example, a target position where the portable terminal 200 is placed, in operation S440, the control unit 150 terminates an operation of controlling movement of the display system 100. If the display system 100 does not arrive at the target point, the control unit 150 iterates the above-described operations.

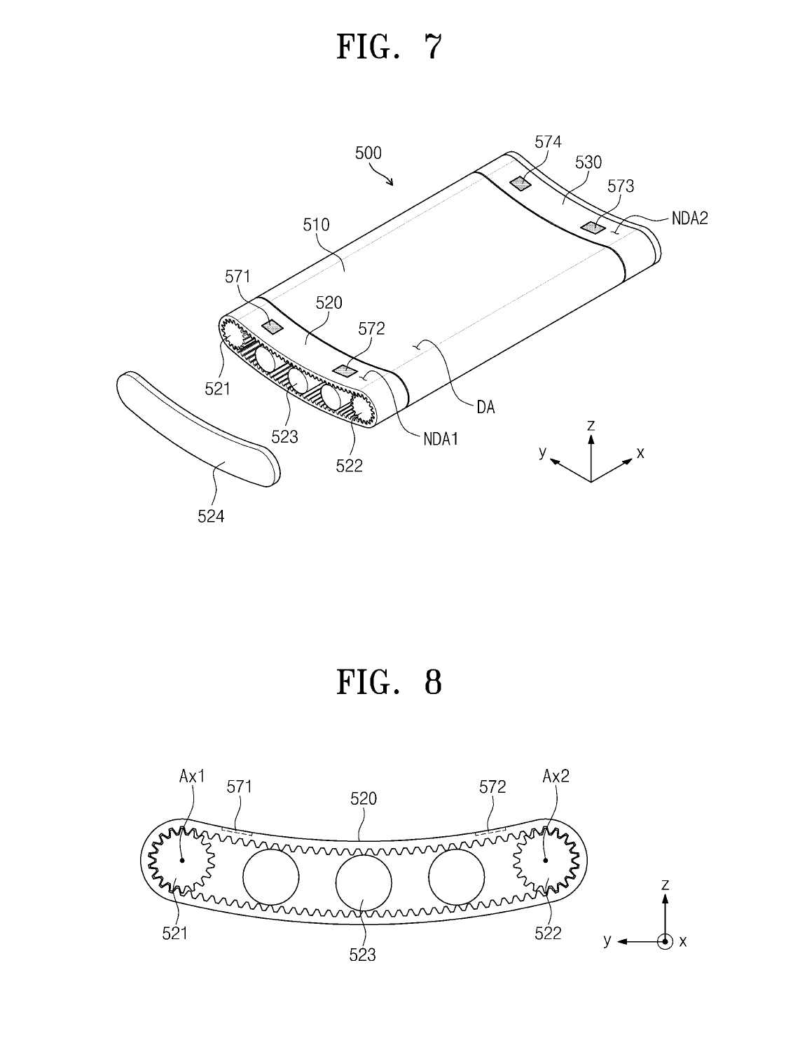

FIG. 7 is a diagram schematically illustrating a display system according to an exemplary embodiment of the inventive concept. FIG. 8 is a cross-section view of a first movement unit of a display system shown in FIG. 7.

Referring to FIGS. 7 and 8, a display system 500 has a long edge in a first direction x, a short edge in a second direction y, and a height in a third direction z. The display system 500 may be one of portable electronic systems, such as a portable telephone, a remote controller, a game console, a POS terminal, a navigation system, a medical terminal, etc.

The display system 500 includes a display panel 510, a first movement unit 520, and a second movement unit 530. The display panel 510 is configured to cover an entire surface of or a substantial portion of the surface of the display system 500. The display panel 510 includes a display area DA, a first non-display area NDA1, and a second non-display area NDA2. The display panel 510 may be a flexible display panel.

The display system 500 may be bent along the second direction y. Thus, all or a portion of the display panel 110 has a shape bent along the second direction y, and the display area DA, first non-display area NDA1, and second non-display area NDA2 have a shape bent along the second direction y.

The first movement unit 520 and the second movement unit 530 may have the same structure. The first movement unit 520 includes a first pulley 521, a second pulley 522, wheels 523, and a cover unit 524. The first pulley 521 rotates on a first axis Ax1 according to rotation of a motor (not shown), and the second pulley 522 rotates on a second axis Ax2 according to rotation of a motor (not shown). The first pulley 521, which rotates on the first axis Ax1, has external saw teeth with a predetermined pitch. The second pulley 522, which rotates on the second axis Ax2, has external saw teeth with a set pitch. A third-direction height of the first axis Ax1 from a bottom surface may be the same as that of the second axis Ax2 from the bottom surface. However, the inventive concept is not limited thereto. For example, a third-direction height of the first axis Ax1 from a bottom surface may be different from that of the second axis Ax2 from the bottom surface.

The display panel 510 covers outer surfaces of the first and second pulleys 521 and 522. Internal teeth, having the same pitch as the external saw teeth of each of the first and second pulleys 521 and 522, are provided on the inside of the first non-display area NDA1 of the display panel 510. That is, the external saw teeth on the inside of the first non-display area NDA1 are on a surface being in contact with the first pulley 521. Thus, the external saw teeth of the first and second pulleys 521 and 522 engage with internal saw teeth of the first non-display area NDA1 of the display panel 510. The first non-display area NDA1 and the second non-display area NDA2 of the display panel 510 may be formed of an elastic material, such as rubber.

The first movement unit 520 has one or more wheels 523, which are disposed between the first pulley 521 and the second pulley 522. The wheels 523 support the first non-display area NDA1 of the display panel 510.

As the first movement unit 520 and the second movement unit 530 rotate, the display panel 510 rotates in a forward direction FD or in a backward direction RD. The display system 500 moves in a second direction y or in a direction opposite to the second direction y according to rotation of the display panel 510. Since the display panel 510 is a flexible display panel, upon rotation and movement, a shape of the display panel 510 may vary according to a shape of a surface being in contact with a bottom surface of the display panel 510.

A first laser sensor 571 and a second laser sensor 572 are provided in the first non-display area NDA1 of the display panel 510. A third laser sensor 573 and a fourth laser sensor 574 are provided in the second non-display area NDA2 of the display panel 510. Although four laser sensors are shown, the invention is not limited thereto. For example, laser sensors may be provided on the movement units 520 and 530, opposite laser sensors 571, 572, 573, and 574.

The first to fourth laser sensors 571 to 574 output lasers, and they receive reflected lasers to calculate a distance between the display system 500 and an obstacle (e.g., walls, home appliances, etc.)

With the above description, the display system 500 may move to a target position in response to a movement command received from an external device. A circuit configuration and an operation of the display system 500 are substantially the same as those described with reference to FIGS. 3 to 6, and a description thereof is thus omitted.

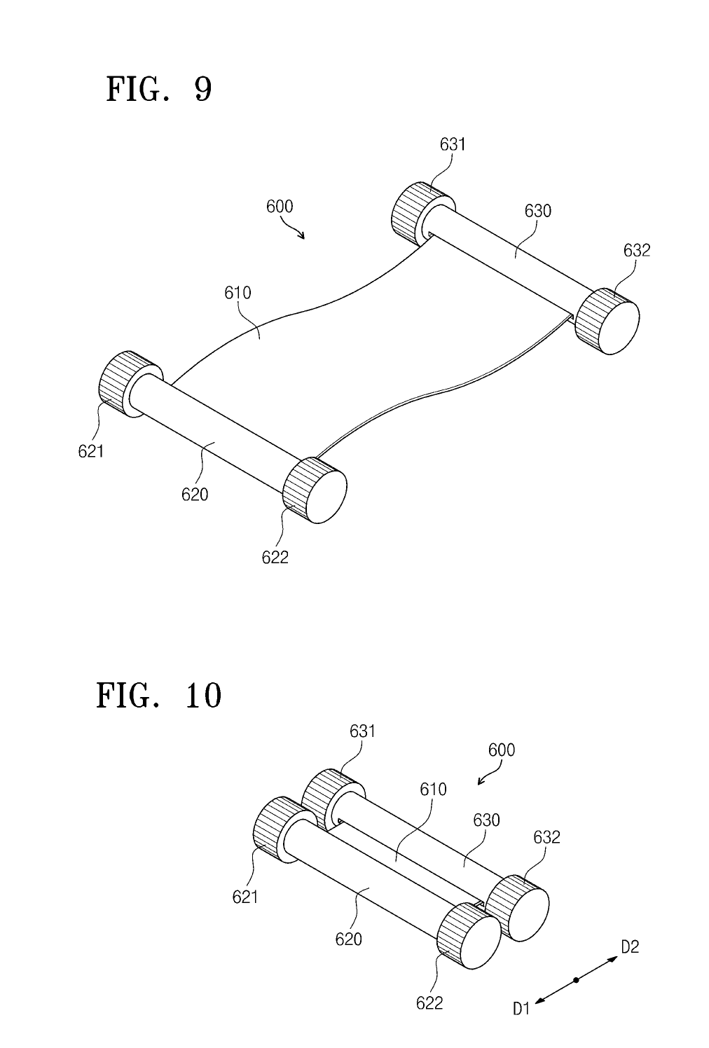

FIG. 9 is a diagram schematically illustrating a display system according to an exemplary embodiment of the inventive concept. FIG. 10 is a diagram schematically illustrating an example where a display panel of a display system shown in FIG. 9 is rolled in first and second rollers.

Referring to FIGS. 9 and 10, a display system 600 includes a display panel 610, a first roller 620, and a second roller 630. The display panel 610 may be a flexible display panel such as a plastic film. A touch film is adhered to the front of the display panel 610 and may sense a touch operation from a user. The display panel 610 has elasticity to be rolled or bent in the form of scroll. The display panel 610 may be rolled in one or both of the first and second rollers 620 and 630. In exemplary embodiments, the display panel 610 may be rolled to be inserted in the first and second rollers 620 and 630.

The display system 600 includes movement units or movable wheels 621, 622, 631, and 632. The wheels 621 and 622 are disposed at both ends of the first roller 620. The wheels 621 and 622 are spaced apart from the first roller 620 and rotate independently from the first roller 620. That is, the first roller 620 does not rotate while the wheels 621 and 622 rotate.

The wheels 631 and 632 are disposed at both ends of the second roller 630. The wheels 631 and 632 are spaced apart from the second roller 630 and rotate independently from the second roller 630. That is, the second roller 630 does not rotate while the wheels 631 and 632 rotate.

A first laser sensor 671 and a second laser sensor 672 are provided in the first roller 620 of the display system 600. A third laser sensor 673 and a fourth laser sensor 674 are provided in the second roller 630 of the display system 600. Although four laser sensors are shown, the invention is not limited thereto. The laser sensors operate in the same manner as described above with reference to the laser sensors shown in FIGS. 1 to 6.

If a movement command is received from an external device with the display panel 610 inserted in the first and second rollers 620 and 630, the display system 600 moves into forward and backward directions D1 and D2 to move to a target point.

At least one of the first and second rollers 620 and 630 may include a circuit configuration described with reference to FIGS. 3 to 6.

The display system 600 with the above-described configuration performs wireless communications with an external device and moves into a target position or the external device in response to a movement command of the external device.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A display system, comprising:
a display unit comprising a flexible display panel;
movement units disposed at first and second ends of the flexible display panel and configured to move the display unit in a set direction;
a transceiver unit configured to transmit and receive a wireless signal;
a laser sensor configured to output a laser and to receive a reflected laser;
a movement route processor configured to calculate a movement route to a target position based on data associated with a sensitivity of a laser sensed by the laser sensor; and
a control unit configured to control the movement units to move the display unit to the target position along the movement route when a movement command is received from an external device by the transceiver unit.

2. The display system of claim 1, wherein the movement units comprise:
a first movement unit disposed at the first end of the flexible display panel; and
a second movement unit disposed at the second end of the flexible display panel.

3. The display system of claim 2, wherein the flexible display panel comprises a display area, a first non-display area, and a second non-display area; and
wherein the first movement unit is disposed in the first non-display area and the second movement unit is disposed in the second non-display area.

4. The display system of claim 3, wherein the first movement unit comprises:
a first pulley disposed around a first driving axis and having external teeth with a pitch;
a second pulley disposed around a second driving axis and having external teeth with a pitch; and
a first motor configured to rotate the first and second pulleys about the first and second driving axes, respectively,
wherein the first non-display area of the flexible display panel has internal teeth that engage with the external teeth of the first and second pulleys.

5. The display system of claim 4, further comprising:
a wheel disposed between the first pulley and the second pulley and to support the first non-display area of the flexible display panel.

6. The display system of claim 3, wherein the second movement unit comprises:
a third pulley disposed around a third driving axis and having external teeth with a pitch;
a fourth pulley disposed around a fourth driving axis and having external teeth with a pitch; and
a first motor configured to rotate the third and fourth pulleys about the third and fourth driving axes, respectively,
wherein the second non-display area of the flexible display panel has internal teeth that engage with the external teeth of the third and fourth pulleys.

7. The display system of claim 1, further comprising:
a battery configured to supply power to the display unit, wherein the control unit blocks a power to the display unit when power remaining in the battery is less than a set amount.

8. The display system of claim 1, wherein the movement units drive the display unit in a first direction or in a direction opposite to the first direction.

9. The display system of claim 8, wherein the flexible display panel is bent along the first direction.

10. The display system of claim 1, wherein the flexible display panel comprises a plurality of pixels connected to a plurality of data lines and a plurality of gate lines.

11. The display system of claim 10, wherein the display unit comprises:
a data driver configured to drive the plurality of data lines;
a gate driver configured to drive the plurality of gate lines; and
a timing controller configured to control the data driver and the gate driver in response to an image signal and a control signal such that an image is displayed on the flexible display panel.

12. The display system of claim 1, wherein the laser sensor is disposed in plurality, and
wherein the plurality of laser sensors is disposed in the first non-display area and the second non-display area of the flexible display panel.

13. An operating method of a display system, the method comprising:
receiving a movement command;
outputting a laser and receiving a reflected laser;
calculating a movement route to a target position based on a sensitivity of the received laser; and
controlling a motor such that the display system is moved,
wherein the motor moves movement units disposed at first and second ends of a flexible display panel.

14. The operating method of claim 13, further comprising:
detecting the remaining power of a battery configured to supply power to the display system; and
blocking power to the flexible display panel when the remaining power of the battery is less than a set amount.
